(19) United States
(12) Patent Application Publication
(10) Pub. No.: US 2015/0123724 A1
(43) Pub. Date: May 7, 2015

(54) CMOS CURRENT-MODE SQUARE-ROOT CIRCUIT

(71) Applicant: KING FAHD UNIVERSITY OF PETROLEUM AND MINERALS, Dhahran (SA)

(72) Inventors: MUNIR A. AL-ABSI, DHAHRAN (SA); IBRAHIM ALI AS-SABBAN, DHAHRAN (SA)

(73) Assignee: KING FAHD UNIVERSITY OF PETROLEUM AND MINERALS, Dhahran (SA)

(21) Appl. No.: 14/072,778

(22) Filed: Nov. 5, 2013

(51) Int. Cl. G06G 7/20

(52) U.S. Cl. CPC G06G 7/20
USPC 327/347

(57) ABSTRACT

A CMOS current-mode square-root circuit includes a square-root circuit configured to compensate for the errors due to the carrier mobility reduction by employing a plurality of MOSFETs in Translinear Loop (MTL). The plurality of MOSFETs are configured to operate in the strong inversion region. The CMOS current-mode square-root circuit is configured to receive an input current and a biasing current, and is further configured to produce an output current based on the input current and the biasing current. The output current based on the input current and the biasing current is described by a first square-root relation and a second square-root relation.

### BACKGROUND OF THE INVENTION

1. Field of the Invention

The present invention relates to electronic circuits, and particularly to a CMOS current-mode square-root circuit.

2. Description of the Related Art

As transistors are scaled down, second order effects become more important and require either modifications to the MOS models, or a way to compensate for the errors due to the second order effects. The main effects that can be compensated for are the channel length modulation, body effect and the carrier mobility reduction. At a large gate-source voltage, the high electric field developed between the gate and the channel confines the charge carrier to a narrower region below the oxide-silicon interface, leading to typically more carrier scattering and, hence, relatively lower mobility. Since scaling has substantially deviated from the constant-field scenario, small-geometry devices can experience significant mobility degradation. Compensation techniques in operational transconductance amplifier (OTA) based circuits exist. However, there is a need to compensate for an error generated by the carrier mobility reduction in current-mode circuits employing a metal oxide semiconductor (MOS) trans-linear loop. Various techniques exist to reduce an error of the output current caused by mobility reduction. The drawbacks to these techniques are that they typically need a control voltage to work properly. Also, changes in the drain-to-source voltage (V_{DS}) of transistors used in such techniques can cause variations in the resistance value, which can affect the functionality of the circuit.

Squarer circuits and/or divider circuits exist which consider second order effects caused by carrier mobility reduction. These circuits generally have a higher precision and smaller chip area. However, a drawback of these squarer circuits and divider circuits is that they typically include the use of resistors to compensate for errors due to the voltage term that is added to the MTL loop, thereby increasing the silicon area of the circuit. Other square-root circuit designs can similarly suffer from the errors caused by carrier mobility reduction.

Thus, a complementary metal oxide semiconductor (CMOS) current-mode square-root circuit addressing the aforementioned problems is desired.

### SUMMARY OF THE INVENTION

Embodiments of a CMOS current-mode square-root circuit include metal oxide semiconductor field-effect transistors (MOSFETs) based on trans linear principles operating in a strong inversion. In embodiments of a CMOS current-mode square-root circuit, the second order effects caused by carrier mobility reduction in short channel MOSFETs can be minimized. The embodiments of a CMOS current-mode square-root circuit compensate for the errors due to the carrier mobility reduction by having MOSFETs in a Trans linear Loop (MTL) type configuration, while also providing a relatively higher precision and a relatively smaller chip area. Tanner simulation tool can be used to confirm the functionality of the embodiments of a CMOS current-mode square-root circuit using a 0.18 μm CMOS technology.

These and other features of the present invention will become readily apparent upon further review of the following specification and drawings.

### BRIEF DESCRIPTION OF THE DRAWINGS

FIG. 1 is a schematic diagram of an embodiment of CMOS current-mode square-root circuit having an integrated circuit including MOSFETs configured in a translinear loop according to the present invention.

FIG. 2 is a plot illustrating simulated results versus calculated results for a CMOS current-mode square-root circuit according to the present invention compared to a conventional square-root circuit.

FIG. 3 is a plot illustrating simulation results for temperature variations on a CMOS current-mode square-root circuit according to the present invention.

FIG. 4 is a plot illustrating simulation results for mismatch analysis on a CMOS current-mode square-root circuit according to the present invention.

Unless otherwise indicated, similar reference characters denote corresponding features consistently throughout the attached drawings.

### DETAILED DESCRIPTION OF THE PREFERRED EMBODIMENTS

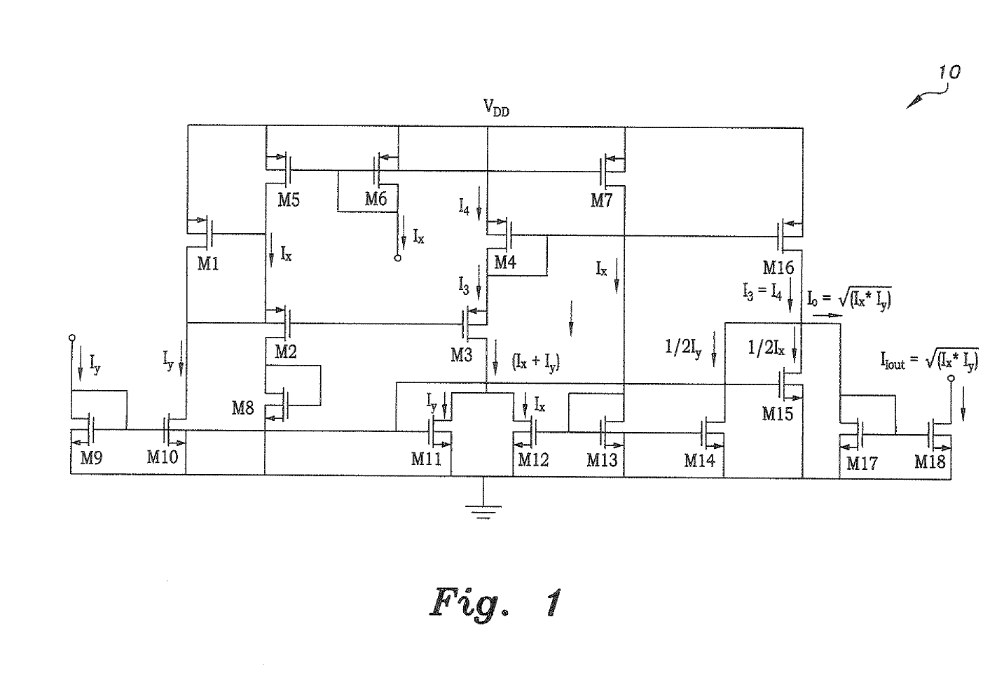

An embodiment of a CMOS current-mode square-root circuit 10, as shown in FIG. 1, includes an integrated circuit which includes a square-root circuit. The input of the CMOS current-mode square-root circuit 10 can be applied via a first input receiving MOSFET, which can be MOSFET M6, or via a second input receiving MOSFET, which can be MOSFET M9. The input can be applied to the MOSFET M6 as Iₓ or the MOSFET M9 as I_{y}, depending on the polarity of the input current to the CMOS current-mode square-root circuit 10. If the input current is positive, then I_{y} can be used as the input and Iₓ can be used as the biasing current. If the input current is negative, then Iₓ can be used as the input and I_{y} can be used as the biasing current.

The CMOS current-mode square-root circuit 10 can have a translinear loop, wherein a plurality of metal-oxide-semiconductor field-effect transistors (MOSFETs) are configured to operate in a strong inversion region. The translinear loop can include the MOSFETs M1 through M4. Using the principle of MOSFETs in a Translinear Loop (MTL) in the MOSFETs M1, M2, M3 and M4, the following relation is obtained:

V_{SG1}+V_{SG2}=V_{SG3}+V_{SG4} (1)

where V_{SG1} is the source to gate voltage for the first MOSFET M1, V_{SG2} is the source to gate voltage for the second MOSFET M2, V_{SG3} is the source to gate voltage for the third MOSFET M3, and V_{SG4} is the source to gate voltage for the fourth MOSFET M4.

If the mobility reduction is taken into consideration, the MOS drain current is given by:

$${I}_{D} = \frac{β {μ}_{0}}{2} \frac{{( {V}_{GS} - {V}_{TH} )}^{2}}{1 + θ ( {V}_{GS} - {V}_{TH} )} . \qquad ( 2 )$$

Where, θ is a fitting parameter and β is the aspect ratio of the transistors. The gate-to-source potential can be given by the relation:

$${V}_{GS} \approx \frac{{I}_{D} θ}{β} + \sqrt{\frac{2 {I}_{D}}{β}} + {V}_{TH} . \qquad ( 3 )$$

Combining equations (1) and (3), the following relation is obtained:

$$\frac{{I}_{D 1} {θ}_{1}}{{β}_{1}} + \sqrt{\frac{2 {I}_{D 1}}{{β}_{1}}} + \frac{{I}_{D 2} {θ}_{2}}{{β}_{2}} + \sqrt{\frac{2 {I}_{D 2}}{{β}_{2}}} = \frac{{I}_{D 3} {θ}_{3}}{{β}_{3}} + \sqrt{\frac{2 {I}_{D 3}}{{β}_{3}}} + \frac{{I}_{D 4} {θ}_{4}}{{β}_{4}} + \sqrt{\frac{2 {I}_{D 4}}{{β}_{4}}} . \qquad ( 4 )$$

Where I_{Di} is the drain current for the transistor i. Assuming that β₁=β₂=β and β₃=β₄=2β and θ₁=θ₂=θ₃=θ₄=θ, then equation (4) can be expressed as:

$$\frac{{I}_{γ} θ}{β} + \sqrt{\frac{2 {I}_{γ}}{β}} + \frac{{I}_{x} θ}{β} + \sqrt{\frac{2 {I}_{x}}{β}} = \frac{{I}_{D 3} θ}{2 β} + \sqrt{\frac{2 {I}_{D 3}}{2 β}} + \frac{{I}_{D 4} θ}{2 β} + \sqrt{\frac{2 {I}_{D 4}}{2 β}} . \qquad ( 5 )$$

Since the drain currents of MOSFETS M3 and M4 can be of equal or substantially equal value, equation (5) can be expressed by the relation:

$$\frac{θ}{β} [ {I}_{x} + {I}_{y} ] + \frac{1}{\sqrt{β}} [ \sqrt{2 {I}_{x}} + \sqrt{2 {I}_{y}} ] = \frac{θ}{2 β} [ 2 {I}_{D 3} ] + \frac{1}{\sqrt{β}} [ 2 \sqrt{{I}_{D 3}} ] . \qquad ( 6 )$$

Next, reducing equation (6) leads to the following condition described by:

$$\frac{θ}{β} [ {I}_{x} + {I}_{y} ] = \frac{θ}{2 β} [ 2 {I}_{D 3} ] ,$$

results in the relation:

I_{D3}=Iₓ+I_{y}. (7)

Combining equations (6) and (7) results in the following relation:

$$\frac{1}{\sqrt{β}} [ \sqrt{2 {I}_{x}} + \sqrt{2 {I}_{y}} ] = \frac{1}{\sqrt{β}} [ 2 \sqrt{{I}_{D 3}} ] . \qquad ( 8 )$$

Squaring both sides of equation (8), gives the following relation:

2[Iₓ+I_{y}]+4\sqrt{Iₓ*I_{y}}=4I_{D3}. (9)

Equation (9) can therefore be written as:

$${I}_{D 3} = \frac{{I}_{x} + {I}_{y}}{2} + \sqrt{{I}_{x} * {I}_{y}} . \qquad ( 10 )$$

Subtracting the term,

$$\frac{{I}_{x} + {I}_{y}}{2}$$

from equation (10), the output current, such as the output current Iₒ and I_{Iout} in the CMOS current-mode square-root circuit 10, can be expressed as a first square-root relation described by:

Iₒᵤₜ=Iₒ=I_{Iout}=\sqrt{Iₓ*I_{y}} (11)

Embodiments of a CMOS current-mode square-root circuit, such as the CMOS current-mode square-root circuit 10, can be used to produce the square root of the current going out of the CMOS current-mode square-root circuit using Iₓ as the input current or the square-root of the current going in to the CMOS current-mode square-root circuit using I_{y} as the input current.

If the current I_{y} is kept constant or substantially constant, and K in equation (12A) is a constant, then equation (11) can be written as a second square-root relation described by:

Iₒᵤₜ=Iₒ=I_{Iout}=K\sqrt{Iₓ}. (12A)

However, when the input current has a positive polarity, Iₓ is the biasing current and is kept substantially constant, and I_{y} is the positive input current, then the second square-root relation can be described by:

Iₒᵤₜ=Iₒ=I_{Iout}=K\sqrt{I_{y}}. (12B)

It is clear from equations (12A) and (12B), that equations (12A) and 12(B) implement the square root using embodiments of a CMOS current-mode square-root circuit, such as the CMOS current-mode square-root circuit 10.

To demonstrate the functionality of embodiments of a CMOS current-mode square-root circuit, the CMOS current-mode square-root circuit 10 was simulated using Tanner tools in a 0.18 μm CMOS technology. The CMOS current-mode square-root circuit 10 can be operated using a 1.3 V power supply, for example. The aspect ratios of the MOSFETS M1-M18 from the CMOS current-mode square-root circuit 10 used for the simulation are listed in Table 1, where channel width/channel length (W/L) is an aspect ratio.

TABLE 1
Transistor aspect ratios
W/L (μm)

| | |
|---|---|
| M1 | 2/0.18 |
| M2 | 2/0.18 |
| M3 | 4/0.18 |
| M4 | 4/0.18 |
| M5 | 2/0.18 |
| M6 | 2/0.18 |
| M7 | 2/0.18 |
| M8 | 1/0.18 |
| M9 | 2/0.18 |
| M10 | 2/0.18 |
| M11 | 2/0.18 |
| M12 | 2/0.18 |
| M13 | 2/0.18 |
| M14 | 1/0.18 |
| M15 | 1/0.18 |
| M16 | 4/0.18 |
| M17 | 1/1 |
| M18 | 1/1 |

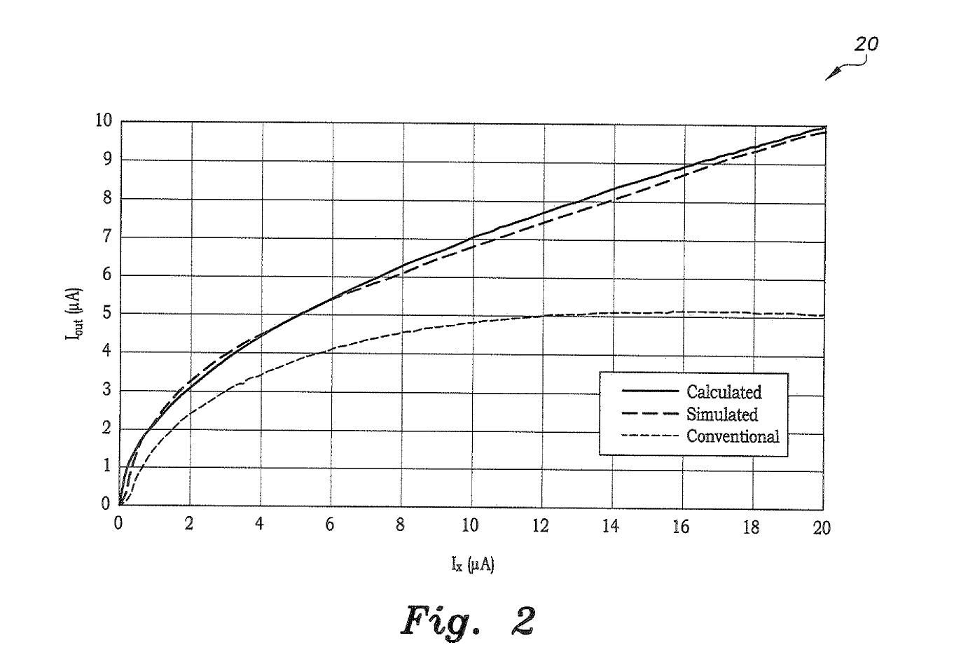

Referring to FIG. 2, the simulation results and the calculated results are shown in plot 20 of FIG. 2 for the CMOS current-mode square-root circuit 10 compared to a conventional square-root circuit, Inspection of the plot 20 shows that the simulated and calculated results are in substantial agreement. In the simulation, the input current I_{y}=5 μA and Iₓ is swept from 0 to 20 μA, for example.

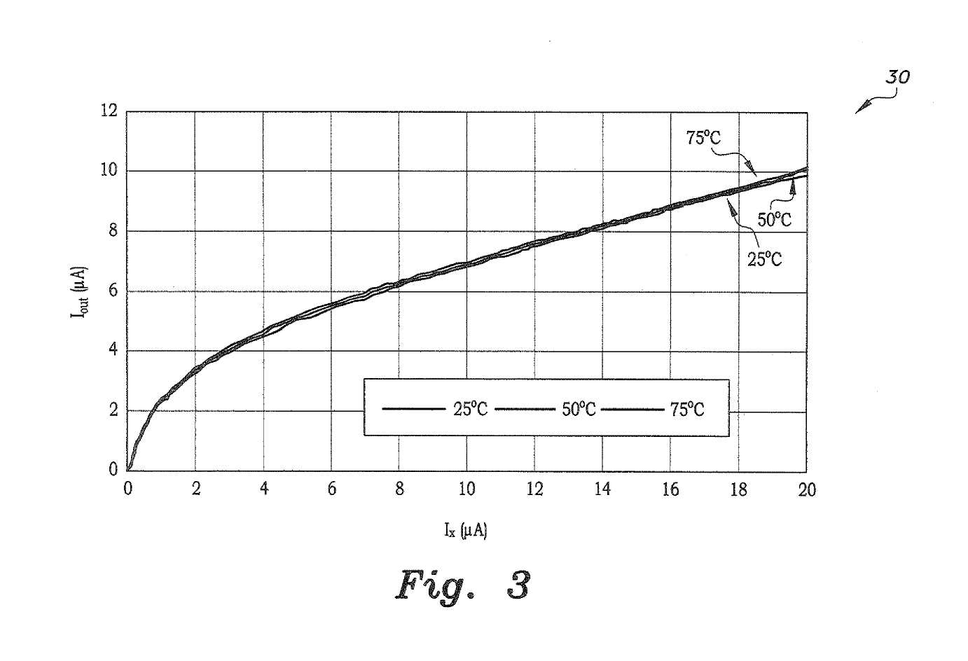

Referring to FIG. 3, with regard to a temperature analysis, the CMOS current-mode square-root circuit 10 was simulated for temperature variation. The temperature was varied from 25° C. to 75° C., for example. The plot 30 of FIG. 3 shows from the simulation results that the CMOS current-mode square-root circuit 10 is relatively resilient to various temperature variations.

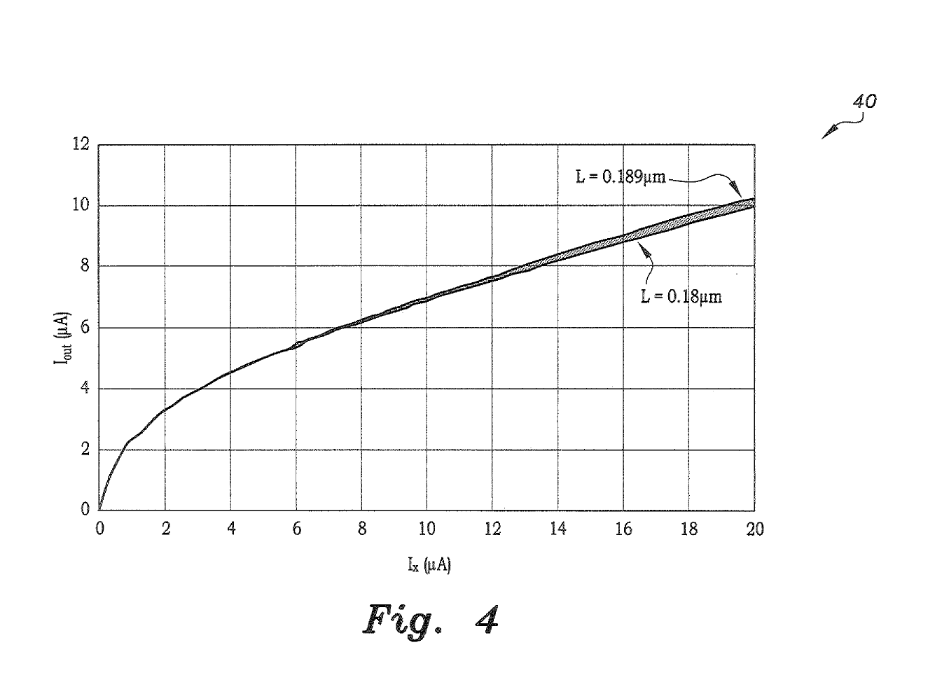

Referring to FIG. 4, with regard to a mismatch analysis, the CMOS current-mode square-root circuit 10 was simulated for mismatch in channel length, for example. The mismatch analysis was carried out for the MOSFETS forming the translinear loop in the CMOS current-mode square-root circuit 10. Inspection of the simulation results shown in plot 40 of FIG. 4 reveal that the variation for mismatch in channel length is within a relatively acceptable range.

In conclusion, the embodiments of a CMOS current-mode square-root circuit, such as using short channel MOSFETs in a strong inversion, have been described. The embodiments of a CMOS current-mode square-root circuit are based on a MTL type configuration with the mobility carrier reduction being relatively minimized, for example. The functionality of the embodiments of a CMOS current-mode square-root circuit are confirmed using Tanner simulation tools, for example.

It is to be understood that the present invention is not limited to the embodiments described above, but encompasses any and all embodiments within the scope of the following claims.

We claim:

1. A complementary metal oxide semiconductor (CMOS) current-mode square-root circuit, comprising:
a square-root circuit configured to receive an input current and a biasing current, the square-root circuit comprising a translinear loop, the translinear loop including a plurality of metal-oxide-semiconductor field-effect transistors (MOSFETs) configured to operate in a strong inversion region;
wherein the square-root circuit implements a first square-root relation between the input current and an output current of the square-root circuit to provide a first square root, the first square root being a square-root of a product resulting from a multiplication of the input current and the biasing current, with the output current being substantially equal to the square root of the product; and
wherein the square-root circuit implements a second square-root relation between the input current and the output current of the square-root circuit to provide a second square root, the second square root being a square-root of the input current multiplied by a constant, where is the biasing current is kept substantially constant.

2. The CMOS current-mode square-root circuit according to claim 1, wherein the square-root circuit further comprises:
a first input receiving MOSFET and a second input receiving MOSFET,
wherein, when the input current has a negative polarity, the first input receiving MOSFET is configured to receive the input current and the second input receiving MOSFET is configured to receive the biasing current.

3. The CMOS current-mode square-root circuit according to claim 2, wherein, when the input current has a positive polarity, the first input receiving MOSFET is configured to receive the biasing current and the second input receiving MOSFET is configured to receive the input current.

4. The CMOS current-mode square-root circuit according to claim 1, wherein the translinear loop comprises a first MOSFET, a second MOSFET, a third MOSFET and a fourth MOSFET, the translinear loop being described by:
V_{SG1}+V_{SG2}=V_{SG3}+V_{SG4}
where V_{SG1} is the source to gate voltage for the first MOSFET, V_{SG2} is the source to gate voltage for the second MOSFET, V_{SG3} is the source to gate voltage for the third MOSFET, and V_{SG4} is the source to gate voltage for the fourth MOSFET.

5. The CMOS current-mode square-root circuit according to claim 4, wherein the drain currents of the third MOSFET and the fourth MOSFET are of substantially equal value.

6. The CMOS current-mode square-root circuit according to claim 1, wherein the square-root circuit further comprises:
a first input receiving MOSFET and a second input receiving MOSFET,
wherein, when the input current has a negative polarity, the negative input current is applied to the first input receiving MOSFET, and the first square-root relation between the negative input current and the output current is described by:
Iₒᵤₜ=\sqrt{Iₓ*I_{y}}
wherein Iₒᵤₜ is the output current, Iₓ is the negative input current, and I_{y} is the biasing current being applied to the second input receiving MOSFET.

7. The CMOS current-mode square-root circuit according to claim 6, wherein the CMOS current-mode square-root circuit is configured to produce the first square root corresponding to the output current, Iₒᵤₜ, the first square root being produced by using the negative input current, Iₓ.

8. The CMOS current-mode square-root circuit according to claim 7, wherein, when the biasing current, I_{y}, is kept substantially constant, the second square-root relation between the negative input current, Iₓ, and the output current, Iₒᵤₜ, provides the second square root, the second square root being described by:
Iₒᵤₜ=K\sqrt{Iₓ}
wherein K is a constant.

9. The CMOS current-mode square-root circuit according to claim 1, wherein the square-root circuit further comprises:
a first input receiving MOSFET and a second input receiving MOSFET,
wherein, when the input current has a positive polarity, the positive input current is applied to the second input receiving MOSFET, and the first square-root relation between the positive input current and the output current is described by:
Iₒᵤₜ=\sqrt{Iₓ*I_{y}}
wherein Iₒᵤₜ is the output current, I_{y} is the positive input current being applied to the second input receiving MOSFET, and Iₓ is the biasing current being applied to the first input receiving MOSFET.

10. The CMOS current-mode square-root circuit according to claim 9, wherein, when the input current has the positive polarity, the CMOS current-mode square-root circuit is configured to produce the first square root, the first square root being produced by using the positive input current, I_{y} as the input current.

11. The CMOS current-mode square-root circuit according to claim 10, wherein, when the input current has a positive polarity, Iₓ is the biasing current and is kept substantially constant, and I_{y} is the positive input current, and the second square-root relation to provide the second square root is described by:
Iₒᵤₜ=K\sqrt{I_{y}}
wherein K is a constant.

12. A Complementary Metal Oxide Semiconductor (CMOS) current-mode square-root circuit, comprising:
a square-root circuit configured to receive an input current and a biasing current, the square-root circuit including a translinear loop comprising a plurality of metal-oxide-semiconductor field-effect transistors (MOSFETs) configured to operate in a strong inversion region; and
wherein the square-root circuit implements a first square-root relation between the input current and an output current of the square-root circuit, when the input current has a positive polarity, to provide a first square root based on a relation between the input current and the output current as:
Iₒᵤₜ=\sqrt{Iₓ*I_{y}}
wherein Iₒᵤₜ is the output current, Iₓ is a current received by a first input receiving MOSFET and acts as a biasing current when the input current has the positive polarity, and I_{y} is a current received by a second input receiving MOSFET and acts as the input current when the input current has the positive polarity.

13. The CMOS current-mode square-root circuit according to claim 12, wherein the square-root circuit implements a second square-root relation between the input current and the output current, when the input current has a negative polarity, to provide a second square root based on a relation between the input current and the output current as described by:
Iₒᵤₜ=K\sqrt{Iₓ}
wherein K is a constant, the current Iₓ received by the first input receiving MOSFET acts as the input current when the input current has the negative polarity, and the current I_{y} received by the second input receiving MOSFET acts as the biasing current when the input current has the negative polarity.

14. The CMOS current-mode square-root circuit according to claim 12, wherein, when the input current has the positive polarity, the current Iₓ acts as the biasing current and is kept substantially constant, and the current I_{y} acts as the positive input current, and a second square-root relation to provide a second square root is described by:
Iₒᵤₜ=K\sqrt{I_{y}}
wherein K is a constant.

15. The CMOS current-mode square-root circuit according to claim 12, wherein the translinear loop comprises a first MOSFET, a second MOSFET, a third MOSFET and a fourth MOSFET, the translinear loop being described by:
V_{SG1}+V_{SG2}=V_{SG3}+V_{SG4}
where V_{SG1} is the source to gate voltage for the first MOSFET, V_{SG2} is the source to gate voltage for the second MOSFET, V_{SG3} is the source to gate voltage for the third MOSFET, and V_{SG4} is the source to gate voltage for the fourth MOSFET.

16. The CMOS current-mode square-root circuit according to claim 15, wherein the drain currents of the third MOSFET and the fourth MOSFET are of substantially equal value.
